(19) United States
(12) Patent Application Publication
(10) Pub. No.: US 2004/0099292 A1
(43) Pub. Date: May 27, 2004

(54) Surface treatment plant for strips that are continuously fed through a treatment receptacle

(76) Inventors: Stefan Volz, Grimlinghausen (DE); Peter Schuler, Recklinghausen (DE); Anders Eklund, Avesta (SE); Olle Danielson, Avesta (SE)

Correspondence Address: Friedrich Kueffner, Suite 910, 317 Madison Avenue, New York, NY, 10017, US

(21) Appl. No.: 10/312,749

(22) PCT Filed: Jul. 3, 2001
(86) PCT No.: PCT/EP01/07587

(30) Foreign Application Priority Data
Jul. 7, 2000 (DE) 100 32 717.6

(51) Int. Cl. B08B 3/04

(52) U.S. Cl. 134/104.2; 134/114; 134/122 R; 134/133

(57) ABSTRACT

In a system for the surface treatment of strips passing continuously through the system, in which the strip passes through a tank filled with the treatment liquid and closed by a cover, the bottom of the tank is designed as a trough in the transverse direction with an essentially horizontal central section and slanting sections descending from the center toward both sides.

The invention pertains to a system for the surface treatment of continuously traveling strip, especially to a pickling system in which the strip passes through a tank filled with the treatment liquid and sealed by a cover.

Before rolled strip can be subjected to further processing, the surface of the strip must be freed of scale. The scale on hot-rolled strip can be taken as an example. So-called “secondary scale” is formed as the strip passes continuously through the hot strip finishing line and over the roller table where it cools and to some extent also in the coiling machine, where the strip is wound up into coils. Depending on the grade of material, on the final thickness of the hot-rolled strip, and on the rolling speed, both the thickness of the scale and its chemical composition can vary.

To eliminate this scale, the most common approach today is to use acid pickling baths. The previously known deep pickling baths are now being replaced by shallow pickling baths. Acid pickling baths of this type can consist of several shallow pickling basins or tanks arranged in a row, which operate with, for example, preheated 18% hydrochloric acid. The strip is pulled or pushed through the pickling tank, during which the layer of scale dissolves in the acid. The concentration of the acid itself becomes depleted during the pickling operation, so that it is necessary to add fresh acid continuously.

In the case of the shallow pickling bath known from DE 36 29 894 A1, the rapid heating of the strip, associated with the exchange of media in the boundary phase between the strip-shaped rolled stock and the treatment liquid, is improved by installation of a treatment channel inside the treatment tank. This channel is sealed off at the top by a cover. The treatment liquid is sprayed from nozzle bars installed at the entry and exit ends. The spray nozzles at the entry and exit ends point in the direction opposite that in which the strip is traveling. To supplement the action of the nozzle bars at the entry and exit ends, it is also possible to provide additional spray nozzles at the sides, underneath the hot-rolled strip, through which the treatment liquid or pickling medium can be sprayed.

The treatment channel of this known pickling system has slide pads or liquid guide pads arranged at the bottom, extending crosswise to the strip travel direction, to support the strip from underneath. So that the desired turbulence is also created underneath the strip between the slide pads or liquid guide pads, guide devices are provided on the sidewalls of the treatment channel, by means of which the treatment medium entering through the nozzle bars is steered in a direction approximately transverse to the strip travel direction. It has been found, however, that, to accomplish the pickling work, a very large volume of the required treatment liquid must be circulated. In addition, the slide pads on the bottom used for support also have a damaging effect on the surface of the strip, which is highly disadvantageous especially when the strip to be treated is made of special steel.

The invention is therefore based on the task of achieving a further optimization of the treatment performed in a system of the type indicated above, especially for cases in which the strip to be pickled is made of special steel.

This task is accomplished according to the invention in that the bottom of the tank is designed as a trough in the transverse direction with an essentially horizontal central section, from which slanted sections descend on both sides. When the strip to be treated is passing through the tank at minimal strip tension, this tension usually being applied by the pinch rolls installed at the entry and exit ends of the tank, the edges of the strip will tend to sag, but the tank design according to the invention prevents these sagging edges of the strip from dragging along the bottom. The extent of the sag at the edges of the strip increases with the width of the strip; this is accommodated by the slanted sections of the bottom, which descend toward the sides.

A preferred embodiment of the invention provides that a treatment channel is designed to expand in the longitudinal direction of the tank, widening out from the entry end to approximately the center of the tank, the other half of the channel from the center to the exit end being a mirror image of the first half. This channel design is based on the realization that the wavy edges resulting from the rolling process are less pronounced at the entry and exit ends because of the action of the pinch rolls, and that the original waviness of the strip gradually returns as the strip continues to travel over the length the tank. The way in which the treatment channel expands is preferably asymmetric; that is, as it proceeds in the longitudinal direction, the bottom of the tank slants more sharply than the cover which forms the boundary of the channel at the top. This creates an enclosure which conforms optimally to the actual course of the strip. The extremely compact channel design thus obtained brings about a considerable reduction in the amount of required strip treatment liquid which must be recirculated.

The contours and especially also the height of the treatment channel, which is bounded by the long walls of the tank, by the bottom, and by intermediate body attached to the cover, is designed to conform to the theoretical course of the strip, which is a function of its tension.

In one embodiment of the invention, an outlet chamber is provided next to at least one of the long walls of the tank. This chamber makes it easy to exchange the liquid as required. If the outlet chamber is also connected to the tank so that the liquid can flow between them and if it is also provided with an overflow weir, the tank can be operated with a defined level of treatment liquid in it.

The outlet chamber is preferably designed to be closed and is equipped with at least one discharge pipe. This reduces the amount of air which can escape to the outside.

In accordance with another proposal of the invention, the slanted sections of the bottom are provided with wear plates, which are preferably made of polypropylene. Even when the strip is very wide and therefore sags to such a degree that the edges come to rest against the bottom of the channel, this contact will not have any disadvantageous effect on the surface of the strip, and especially in the case of strip made of special steel it is possible to preserve the strip from damage throughout its passage through the tank.

This safe passage of the strip is also ensured advantageously by slide bars, preferably made of polypropylene, which are installed on the inside surface of the long walls of the tank. These bars protect the strip if it should happen to wander, that is, if it should deflect toward the side.

In the case of a system with more than two tanks, one following the other in the direction of strip travel, it is proposed in accordance with the invention that a spray pickling unit be installed between two tanks. In this way, the efficiency of the pickling step is increased, because the strip can be wetted with additional acid.

Further details and advantages of the invention can be derived from the claims and from the following description of embodiments, which are illustrated schematically in the drawings:

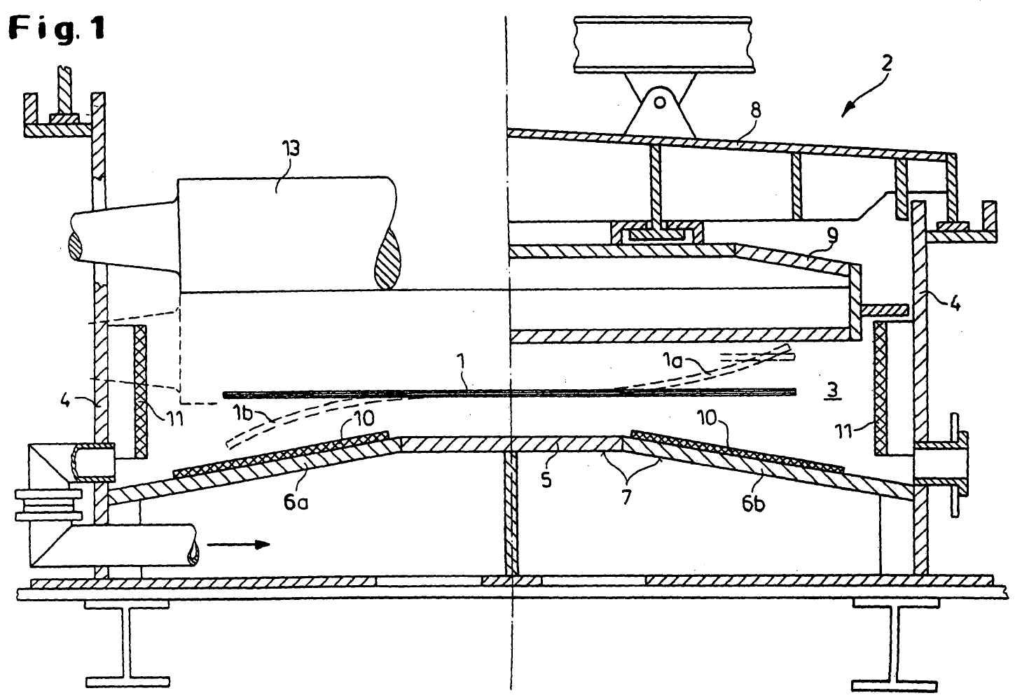

FIG. 1 shows a cross section through a tank of a treatment system;

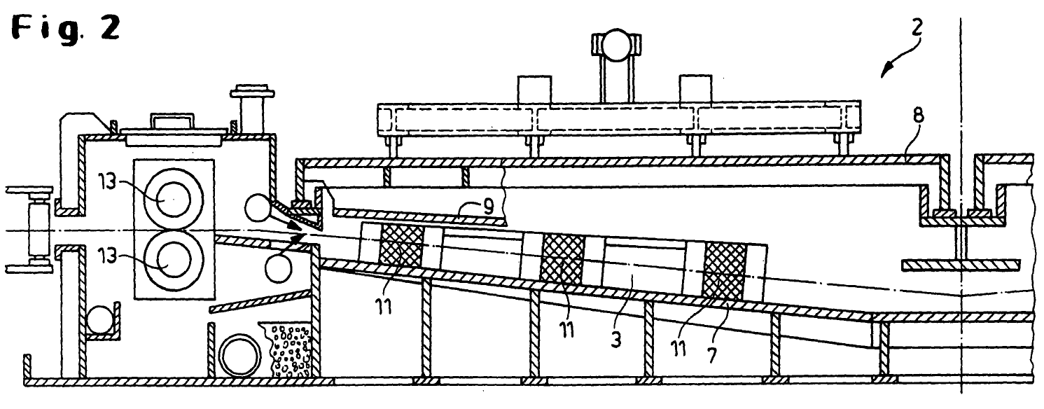

FIG. 2 shows a longitudinal section through the tank according to FIG. 1 over about half its length;

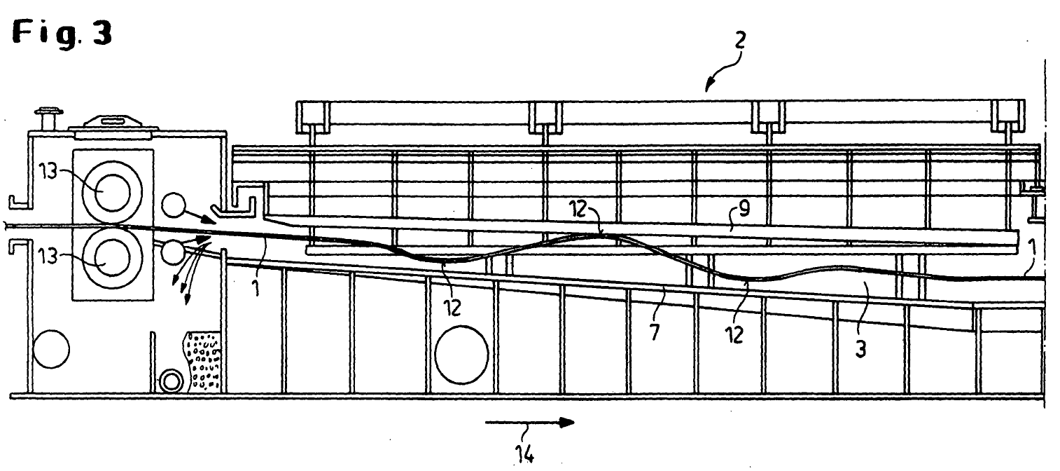

FIG. 3 shows a longitudinal view corresponding to the diagram of FIG. 2 with indication of the waviness at the edges of the strip to be treated;

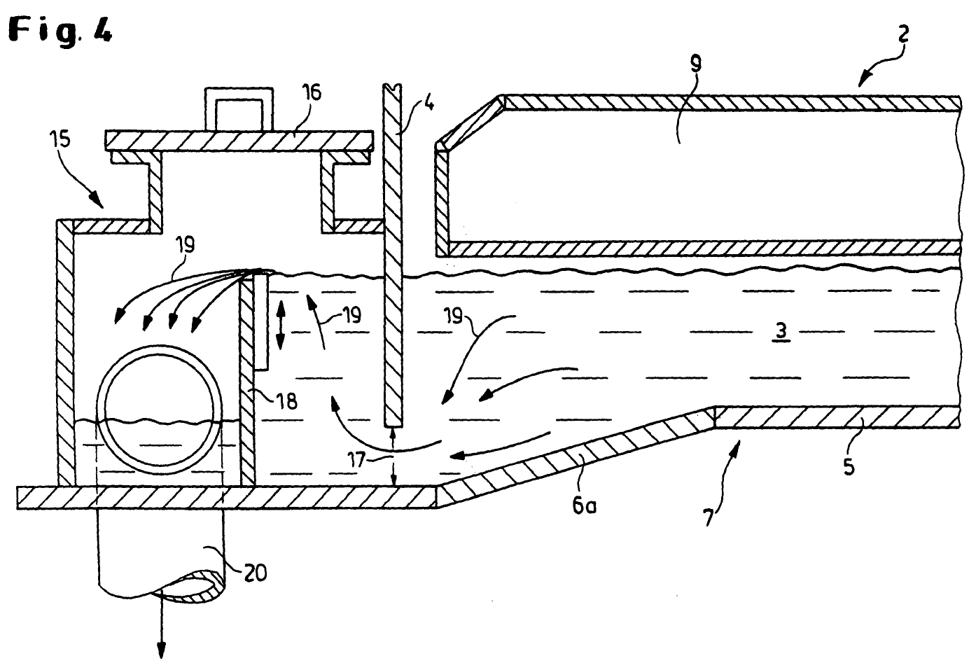

FIG. 4 shows a cross section of a detail of an outlet chamber, isntalled next to the tank; and

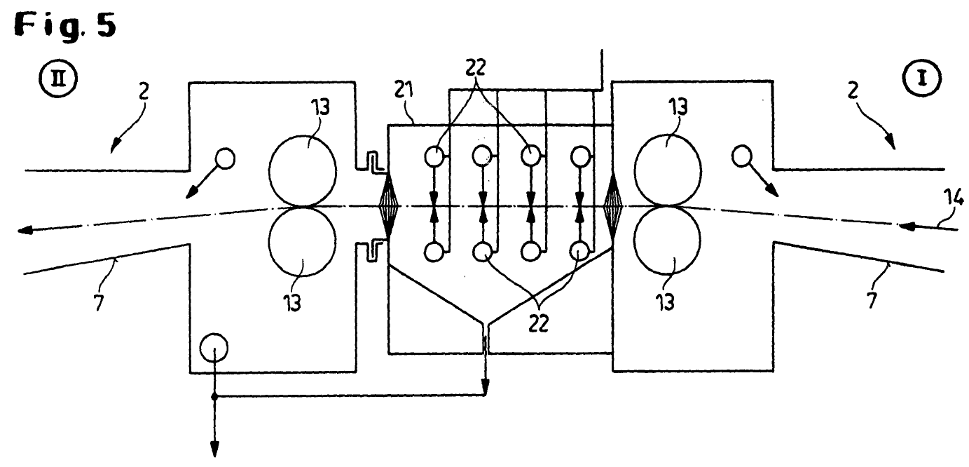

FIG. 5 shows a spray pickling unit installed between two treatment tanks.

FIG. 1 shows a tank 2, which belongs to a system for the surface treatment of strip material 1, passing continuously through the system. The tank has a treatment channel 3, the boundaries of which are defined by the long tank walls 4; by a bottom 7, which has an essentially horizontal central section 5 and slanted sections 6a, 6b, which slant downwards from the center toward both long walls; and a cover 8, to which an intermediate cover or a float 9 is attached. At maximum strip tension, the continuous strip 1 takes the form 1a shown schematically in broken line in FIG. 1 and, at minimum strip tension, it takes the form 1b, also shown schematically in broken line. Each of these forms, i.e., the one assumed at maximum, the other at minimum tension, obviously extends across the entire width of the strip, one side as a mirror image of the other. The S-shaped deviation shown in the figure thus develops over the course of the change from maximum to minimum tension. The height of the channel 3 is thus dimensioned so that it is sufficient to accommodate this theoretical S-shaped form of the strip but also so that the least possible amount of extra space is provided.

The slanted sections 6a, 6b of the bottom 7 also take care of satisfying the demand for the narrowest possible channel cross section and therefore for the smallest possible dimensions of the channel 3. The design ensures the safe passage of the strip not only in the case of a strip form 1b at minimum strip tension but also in the case of wider strip with even greater lateral sag. If the edges of the strip 1 actually do come into contact with the slanted sections 6a, 6b, wear plates 10 of polypropylene, which are welded by their edges to the bottom, ensure safe contact. In addition, slide bars 11 of polypropylene installed along the long walls of the tank also ensure safe contact in cases where the strip 1 wanders toward one side of the tank 2 or the other.

The channel 3, however, is not constructed only in consideration of the sag of the strip but also under consideration of the waviness of the edges of the strip 1, which is the unavoidable result of the rolling process. FIG. 3 draws attention to the edge waviness 12 of the strip 1. The pairs of pinch rolls 13 installed at the entry and exit ends of each tank 2 reduce the effect of these waves in these areas; that is, the waves are relatively small at the entry end and then increase in size in the strip travel direction, indicated by the arrow 14, over the length of the tank until they return to their original height in the middle of the figure. The form of the strip in the other half of the tank 2 (not shown) is a mirror image of that in the first half. As can be seen in FIG. 2, the channel 3 is adapted to this form of the strip and thus is designed to expand toward the center of the tank. The height of the tank is thus smaller at the entry end and at the exit end (not shown) and becomes gradually larger toward the center.

In the design of the tank according to FIG. 2, an outlet chamber 15 for the treatment liquid is provided at the side of the tank. This chamber is closed all around the periphery and by a cover 16 on top, and it is also connected to the treatment channel 3 by a gap 17 between the bottom 7 of the tank 2 and the long wall 4 to allow the flow of liquid. The outlet chamber 15 is equipped with an overflow weir 18, over which the treatment liquid leaving the treatment channel 3 and proceeding toward the outlet chamber 15, as indicated by the arrows 19, must pass. This has the effect of determining the level to which the liquid can fill the tank. The treatment liquid then flows from the outlet chamber 15 through a discharge pipe 20.

In the exemplary embodiment according to FIG. 5, an additional spray pickling unit 21 is installed between the two tanks 2/I, 2/II, which are arranged in sequence in the strip travel direction 14. This spray unit has several spray bars 22 above and below the course of the strip. As a result of this supplemental wetting of the surfaces of the strip with acid, the efficiency of the pickling operation is increased even more.

1. System for the surface treatment of strips passing continuously through the system, especially a pickling system, in which the strip passes through a tank filled with the treatment liquid and sealed by a cover, characterized in that the bottom (7) of the tank (2) is designed as a trough in the transverse direction with an essentially horizontal central section (5), from each side of which slanting sections (6a, 6b) proceed downward.

2. System according to claim 1, characterized in that a treatment channel (3), extending in the longitudinal direction of the tank (2), expands from the entry end to approximately the middle of the tank, its shape from that point to the exit end being essentially a mirror image of the first half.

3. System according to claim 2, characterized in that the treatment channel (3) expands asymmetrically.

4. System according to claim 2 or claim 3, characterized in that the boundaries of the treatment channel (3) are formed by the long walls (4) of the tank, by the bottom (7), and by an intermediate body (9) installed on the cover (8).

5. System according to one of claims 1-4, characterized by an outlet chamber (15) next to at least one of the long walls (4) of the tank.

6. System according to claim 5, characterized in that the outlet chamber (15) is connected to the tank (2) in such a way as to allow the liquid to flow between them and is equipped with an overflow weir (18).

7. System according to claim 5 or claim 6, characterized in that the outlet chamber (15) is closed and is provided with at least one discharge pipe (20).

8. System according to one of claims 1-7, characterized in that the slanting sections (6a, 6b) of the bottom (7) are provided with wear plates (10).

9. System according to claim 8, characterized by wear plates (10) made of polypropylene.

10. System according to one of claims 1-9, characterized in that a spray pickling unit (21) is installed between two tanks (2/I, 2,II) which follow one another in the strip travel direction.

11. System according to one of claims 1-10, characterized in that the inside surface of the long walls (4) of the tank are provided with slide bars (11).

12. System according to claim 11, characterized by slide bars (11) made of polypropylene.
